(19) United States
(12) Patent Application Publication
(10) Pub. No.: US 2019/0384811 A1
(43) Pub. Date: Dec. 19, 2019

(54) SYSTEM AND METHOD FOR COMMUNICATION EXCHANGE FEEDBACK

(71) Applicants: Pubali Sen, (US); Assaf Namer, (US)

(72) Inventors: Pubali Sen, San Jose, CA (US); Assaf Namer, Sunnyvale, CA (US)

(21) Appl. No.: 16/008,074

(22) Filed: Jun. 14, 2018

(51) Int. Cl. G06F 17/27; G10L 15/22; G10L 15/18; H04L 29/06

(52) U.S. Cl. CPC G06F 17/279; G06F 17/273; G06F 17/274; G10L 2015/225; G10L 15/18; H04L 65/605; H04L 65/403; G10L 15/22

(57) ABSTRACT

The present invention provides a system for communication exchange feedback for a communication in between a plurality of participants. The system includes at least one device corresponding to each participant. The device is configured to pick up any communication input like verbal or typing etc. The device may be connected to an interception module which is configured to analyze the communication exchange inputs received from the at least one device. The interception module may further analyze the communication exchange and provide its feedback to the user that are based on a number of communication parameters.

### TECHNICAL FIELD

This invention relates to a feedback management system and method and more particularly to providing feedback to parties involved in a communication exchange.

### BACKGROUND OF THE INVENTION

Communication exchange is an integral part of everyone's lives. With the economies opening up and users learning new languages and interacting with varied people day by day, effective communication is one that forms a major part of a good communication exchange. Good communication is not only realized by using grammatically correct script, but, also covers usage of filler words, confidence levels, sentiments etc.

There are various techniques available to provide users with the required feedback to its users. However, there exists the need for a better solution to provide feedback to a communication exchange between multiple participants.

### SUMMARY

The present invention provides a feedback system and a method for a communication exchange having one or more of the features recited in the appended claims and/or one or more of the following features, which alone or in any combination may comprise patentable subject matter:

Accordingly, in an embodiment of the invention, there is provided a system for communication exchange feedback for a communication between a plurality of participants. The system includes at least one device, corresponding to each of the plurality of participants configured for communication exchange. This device may include a plurality of input modules, to receive communication exchange inputs actively and passively. Further, the device includes a plurality of output modules configured to provide output.

Further, the system includes an interception module, communicatively connected to the at least one device. The interception module is configured to be initiated by a communication exchange. The interception module includes a communication determination module that identifies presence of a communication from the communication exchange inputs received by the plurality of input modules. Further, the interception module includes a communication evaluation module, configured to analyze the communication exchange of the plurality of participants. The communication evaluation performed by the communication evaluation module is based on a plurality of communication parameters. The interception module, further includes a feedback module communicatively coupled to the communication evaluation module and is configured to generate a feedback wherein the feedback is provided to each of the plurality of participants, based on communication evaluation of the communication exchange.

Accordingly, in another embodiment of the invention, there is provided a computer implemented method for communication exchange feedback provided by an interception module, connected to a device. The method includes receiving communication exchanges between a plurality of participants through a plurality of input modules of the device. The method includes steps of identifying and analyzing the communication exchange inputs and generating a feedback based on the communication evaluation of the communication exchange.

Additional features and advantages are realized through the techniques of the present disclosure. Other embodiments and aspects of the present disclosure are described in detail herein and are considered a part of the present disclosure. For a better understanding of the present disclosure with advantages and features, refer to the description and to the drawings.

### BRIEF DESCRIPTION OF THE ACCOMPANYING DRAWINGS

The foregoing summary, as well as the following detailed description of various embodiments, is better understood when read in conjunction with the drawings provided herein. For the purpose of illustration, there is shown in the drawings exemplary embodiments; however, the presently disclosed subject matter is not limited to the specific methods and instrumentalities disclosed.

FIG. 1A is a line diagram illustrating exemplary environment wherein various embodiment of the invention may function.

FIG. 1B is a line diagram illustrating another exemplary environment wherein various embodiment of the invention may function.

FIG. 2 is a block diagram illustrating a system for communication exchange feedback, in accordance with an embodiment of the invention.

FIG. 3 is a block diagram illustrating a device in accordance with an embodiment of the invention.

FIG. 4 is a block diagram illustrating an interception module in accordance with an embodiment of the invention.

FIG. 5A is a flow chart illustrating a communication exchange feedback method, in accordance with an embodiment of the invention.

FIG. 5B is a flow chart illustrating a communication exchange feedback method, in accordance with another embodiment of the invention.

FIG. 6 is a flow chart illustrating communication identification method, in accordance with an embodiment of the invention.

FIG. 7 is a block diagram of an exemplary computer system, in accordance with an aspect of the embodiments;

### DETAILED DESCRIPTION OF THE INVENTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

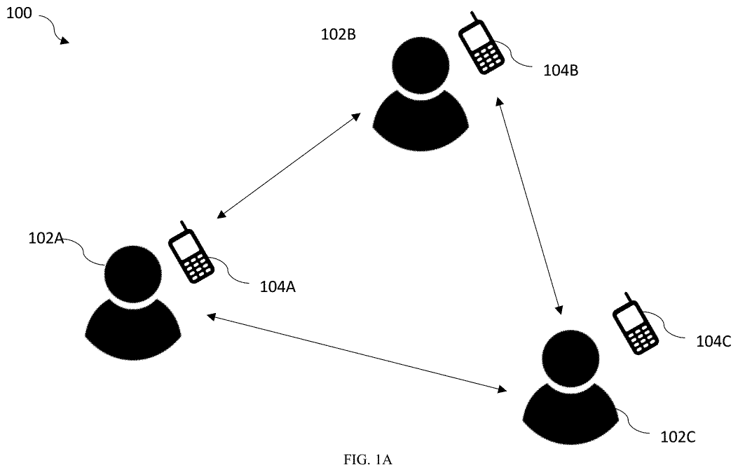

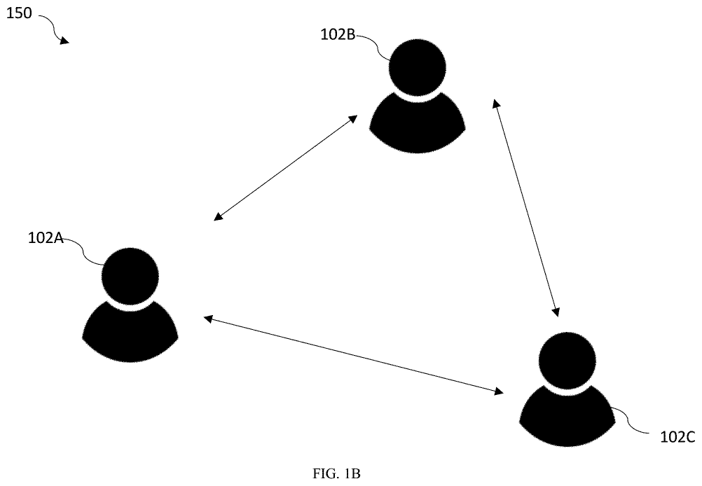

Referring now to FIG. 1a, a line diagram illustrates an exemplary environment 100, wherein various embodiments of the invention may function. The environment 100 includes a plurality of participants 102A-102C (collectively referred to as participants 102). Each of the participants 102 may have a corresponding devices 104A-104C (collectively referred to as communication units 104). The participants 102 may be conversing over a network (not shown in the Figure). The network may be any one of a cellular or other wireless network like internet, Wi-Fi, wireless LAN, etc. The communication units 104 may be anyone of a smartphone, a smartwatch, a laptop computer, a desktop computer, a tablet computer, a smart TV, a webcam, a video camera, an audio recorder, smart speaker, voice enabled devices, car infotainment, and a smart headset.

Referring now to FIG. 1B, a line diagram illustrates another exemplary environment 150, wherein various embodiment of the invention may function. The environment 100 includes a plurality of participants 102A-102C (collectively referred to as participants 102). The participants 102 may be conversing to each other in physical presence of each other without actively using any communication units 104.

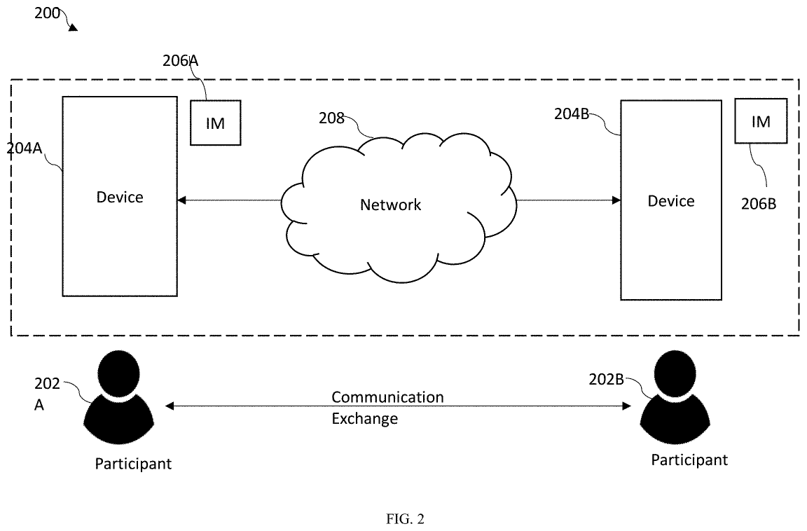

Referring now to FIG. 2, a block diagram illustrating a system 200 for communication exchange feedback. The system 200 may include a plurality of devices 204A, 204B, interception modules (IM) 206A, 206B, and a network 208.

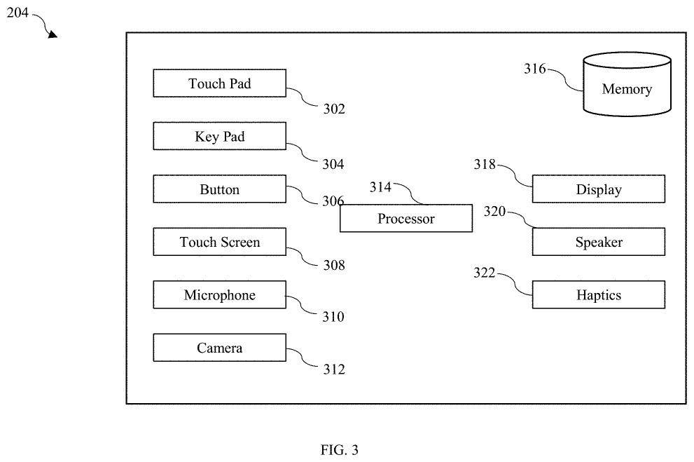

The plurality of communication devices 204A, 204B may be anyone of a smartphone, a smartwatch, a laptop computer, a desktop computer, a tablet computer, a smart TV, a webcam, a video camera, an audio recorder, smart speaker, voice enabled devices, car infotainment, and a smart headset as described above. The plurality of communication devices 204A, 204B may include further components which will be described later in the description in conjunction to FIG. 3.

Each of the plurality of communication devices 204A, 204B are communicably connected to corresponding interception modules (IM) 206A, 206B (referred to as IMs 204). IMs 204 may be hardware devices or software application embedded on installed within the communication devices 204A, 204B.

Network 208 is configured to allow communication of communication devices 204A, 204B. Network 208, may be wireless or wired network. Wireless network may be anyone of a WI-FI, Bluetooth, Cellular, wireless Local Area Network (LAN), Zigbee, etc. Wired network may be Local Area Network (LAN), Wide Area Network (WAN), or Metropolitan Area Network (MAN) etc.

The system 200 may be initiated by a communication exchange feedback between a plurality of participants 202A, 202B. The communication devices 204A, 204B includes various components (as will be described later) to identify communication exchange and get triggered by it. The system 200, may work in online mode or offline mode.

By way of an example, the working of the invention is being described herewith without limiting the scope of the invention. Considering the communication devices 204A, 204B as smart phones, IMs 206A, 206B as software applications that may be pre-installed in the OS of the smart phones or may be installed by user of the smartphones by downloading. Online Mode

The participants 202A, 202B may initiate a communication on their devices 204A, 204B (referred to as communication devices 204) for example make a call from their smartphone or a laptop etc. The communication devices 204 may be provided with corresponding IMs 206A, 206B. IMs 206A, 206B may be pre-installed with the communication devices 204 or may be downloaded and installed by the users. Communication devices 204 will be referred to as smartphones 204 for the purposes of explanation. Smartphones 204 are configured to pick up communication exchange through various input modules that will be described later in the description. Communication exchange may be voice communication, textual communication etc. Once the communication exchange has been picked up by the smartphones 204, the IMs 206A, 206B are initiated. The IMs 206A, 206B determine whether the communication inputs qualify as communication exchange. This may be done using various set of rules to identify two sided or one-sided communications. Once the communication exchange is identified, the IMs 206A, 206B start recording the communication exchange. Further, the IMs 206A, 206B (components explained later in detailed description), analyze the communication. Also, the communication exchange is compared for each of the participants with a set of rules or guidelines. The rules may be concerning anyone of a language, filler words, confidence index, sentiment breakdown, accent analysis, negative words, sentence construction, using wrong terminology, and use of personal words. The IMs 206A, 206B may be configured to be adaptive and self-learning so as to understand and make adjustments to the set of rules or guidelines in real time based on the type of communication exchange, environment, and the profile of the users 202A, 202B. Further, based on the above-mentioned parameters, the IMs generate a feedback to the users 202A, 202B. The feedback may be configured to be sent in real time, after the communication exchange, at a fixed time, or to be fetched on user's action. The feedback is provided to all the parties to the communication exchange based on their respective utterances during the conversation and also by understanding the profile of such user. Profile of a user may be based on the feedbacks provided to the user in the past, his adoption of the feedback and change in his communication style based on the feedback and progress.

According to an embodiment of the invention, system 200 may provide real-time pronunciation feedbacks to the user based on the previous conversations. In case a user has used wrong pronunciation for a word in his previous conversations. During future conversation, if the system 200 detects that the same topic is being discussed it will provide “dos and don'ts” for pronunciation to the user in real-time.

### Offline Mode:

In this mode the users' smartphones 204 may be configured to pick up communication inputs when the communication is not through the smartphones 204. For e.g., when a person speaks with another person physically while the smartphone is in his pocket or in hand. The smartphones, pick up communication exchange through various components, to be described later, and send the communication inputs to the IMs 206A, 206B. The IMs 206A, 206B, being in the offline mode record the conversation and store the feedbacks in a memory. In other embodiments, the feedback may be provided to the users 202A, 202B through notifications to respective smartphones 204.

In other embodiments of the invention, IMs 206A, 206B may be some other wearable device like a smartwatch, or a smart ring or any other wearable device.

In another embodiment, the IMs 206A, 206B may be remote servers to which the communication exchanges are sent in real time for real time feedbacks over. A communication network may be like network 208.

In an embodiment of the invention, the present invention may be utilized for providing feedback for general communication exchanges.

In another embodiment of the invention, the present invention may be utilized for providing feedback during a language training course.

In another embodiment of the invention, the present invention may be utilized for providing feedback during a public speaking course.

In another embodiment of the invention, the present invention may be utilized for providing feedback during a written communication training.

In another embodiment of the invention, the present invention may be utilized for providing feedback to improve speaking habits of a user.

In another embodiment of the invention, the system 200 may also be utilized to track a user's improvements in speaking habits over time.

In another embodiment of the invention, the present invention may be utilized for providing feedback to improve written communication of a user.

Referring now to FIG. 3 a block diagram, illustrates the communication device 204 and its various internal components. The communication device 204 may include a plurality of input modules configured to pick up input from the user. Input modules may be anyone or a combination of a touch pad 302, a key pad 304, a single button 306, a touch screen 308, a microphone 310, and a camera 312. The communication device 204 may further include a processor 314, operatively and communicably connected to the multiple input modules. Further, the communication device 204 also includes a memory 316, a display unit 318, a speaker 320 and a haptics unit 322.

The touch pad 302 may be a pad initiated by sensing touch of a user. For example, touch pad of a Portable Digital Assistant (PDA), a laptop, a communicator etc. the touch pad 302 may be configured to receive user inputs.

The key pad 304 may be a general keypad to receive user inputs for a textual or a written communication. The key pad 304 may be an integral key pad as for example of a laptop, may be an ad-hoc hardware device as for example to a personal computer. Further, the keypad 304 may be a physical key board like in a laptop or may be a virtual key pad as is present in modern day smartphones or laptops etc. Key pad 304 recognizes key strokes and hence picks up the communication inputs form the user.

According to an embodiment of the invention, the textual inputs may be from a text message application, an email application, a messenger application, or any social media application as well.

Button 306 may be a single standalone input button. The button may be able to identify user inputs for example in radio device.

Touch screen 308 may be a screen configured to identify touch input from the user. the touch screen may be in form of a touch pad as described earlier or a key pad also as described earlier.

Microphone 310, may be a general microphone able to pick up conversation sounds. The microphone 310 picks up the sounds and hence send them for further determination. It may be a single standalone microphone or an array of microphones working together to pick up sounds from any direction.

Camera 312 is a general camera configure to pick up motion of a user as a part of communication. It may help in sign communication followed by a verbal communication. It may also be helpful to understand a user's emotional state during the communication.

Processor 314, may be a general or a specific microcontroller. Processor 314 may be a single core or multicore processor. Processor 314 may comprise at least one data processor for executing program components for executing user- or system-generated requests.

Memory 316 may be without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Display 318 may be a general display screen configured to display various graphics, text etc. to the user. The display screen may be anyone of a Light Emitting Diode (LED) screen, Liquid Crystal Display (LCD) screen, a plasma screen, etc. Display screen 318 is communicably connected to the processor 314.

Speaker 320 is configured to provide an audible notification. Speaker 320 may be a standalone speaker or an array of speakers to provide audible notifications. Haptics unit 322, may be configured to provide haptic alert to a user like vibration etc. This may be configured to automatically switch on when the communication device 204 is in silent mode.

In another aspect of the invention, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

In an exemplary operation, the input modules namely touch pad 302, key pad 304, single button 306, touch screen 308, microphone 310, and camera 312 (collectively referred to as input modules) are configured to pick up any sort of communication initiated by the user.

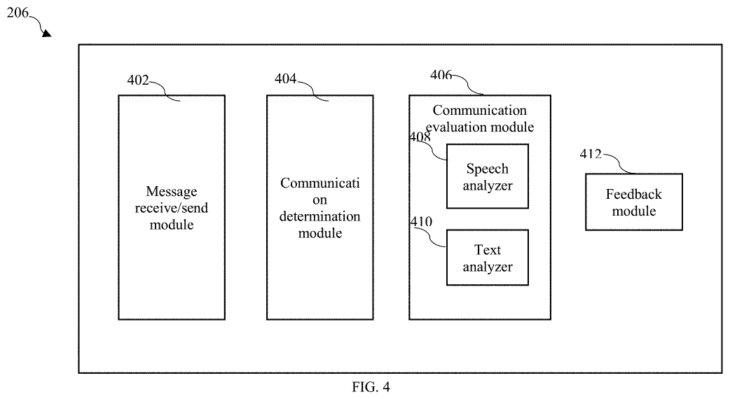

The input modules collect communication inputs like key stroke, or calling someone, or general conversation to a physically present person without using the communication device 204. The communication inputs identified may then be forwarded to the processor 314 that may store the same in the memory 316. Also, simultaneously, the communication inputs may be forwarded to the IM 206 (to be described in detail in conjunction with FIG. 4) for further analysis. The processor 314 may then receive the feedback based on the communication inputs that are shared and the profile of the user, stored within the memory 316. The processor may then decide what type of alert is to be provided based on the user configuration of the system 200.

In an embodiment of the invention, the memory 316 may be a local memory or a remotely placed memory. The profile of the user containing historically provided feedbacks, rate of adoption of feedback, changes done to one's communication profile etc. The processor 314 may be configured to understand the feedback provided and determine in case the feedback has been adopted by a user in his subsequent communication exchanges. This information may then be utilized to rank or score the user's profile and the feedback provided may also be based on the profile. The processor, along with the communication exchange also shares the user profile and profile score with the IM 206. The profile may also be stored by the IM 206.

In another embodiment of the invention, the processor 314 may also be configured to determine communication exchange. For example, if the user receives a message and the user opens the message, the processor 314 may sense that the user may deduce that the user may respond to the message and hence be ready for the communication exchange sharing with the IM 206. For this the processor 314 may be configured to note user's behavior about written or verbal communications. Configuration may be done when the IM 206 is downloaded and installed on the communication device 204. In other embodiments, the configuration of the processor 314 may be done when the hardware IM 206 is connected to the communication device 204.

Referring now to FIG. 4, a block diagram, illustrates the IM 206 in accordance with an embodiment of the invention. The IM 206, as described above, may be a hardware device or may be realized as a software. The IM 206 may include multiple modules to perform various functions. The various modules may be message receive/send module 402, communication determination module 404, communication evaluation module 406, and a feedback module. The IM 206 may also include a memory (not shown in figure).

When realized as software, the modules may be machine-readable instructions which, when executed by a processor/processing module, perform any of the described functionalities. The machine-readable instructions may be stored on an electronic memory device, hard disk, optical disk or other machine-readable storage medium or non-transitory medium. In an implementation, the machine-readable instructions can also be downloaded to the storage medium via a network connection.

In another aspect of the invention, the modules may be different hardware microcontrollers configured to carry out different functions. The different modules function collectively to obtain the final output.

The communication evaluation module 406, may further include a speech analyzer module 408 and a text analyzer 410.

Message receive/send module 402 is configured with transceiver function. It is configured to send and receive messages. Message receive/send module 402 is communicably connected to the processor 314 of the communication device 204.

For IM 206 realized as software, there may be a software patch provided to connect the processor 314 with the message receive/send module 402.

For IM 206 realized as hardware, the communication between the processor 314 and the message receive/send module 402 may be wireless.

The message receive/send module 402 is configured to receive the communication inputs from the processor 314. The message receive/send module 402 is further communicably connected to the communication determination module 404. The communication determination module 404 is configured to identify the kind of communication inputs. The communication inputs may be either verbal or written/textual communication input. Communication determination module 404 may also be further configured to determine whether the communication input qualifies as a possible communication. The communication determination may be performed by analyzing words and sentences uttered.

Communication determination module 404 is further communicably connected to communication evaluation module 406. Communication evaluation module 406 analyzes the communication inputs in real time and continuously. If the communication input is identified as verbal communication, then the speech analyzer 408 analyzes the communication inputs. In case, the communication input is textual/written then the text analyzer 410 analyzes the communication inputs. It is to be noted that the communication inputs may be realized in real time continuously or may be stored in memory to be analyzed later in time.

Communication analysis may be performed on the basis of pre-fed instructions or rules set. Further, the communication evaluation module 406 may also be adaptive learning module. It may learn the way of speaking of a particular user and may define its own rules set which may be defined in a broad sense by the user or guidelines of the IM 206.

According to an embodiment the adaptive learning may adapt itself to generate feedback based on the topic of conversation like technology, market segment, audience background etc. For example, when talking to non-experts in a specific market user may be provided a feedback to not use too many acronyms.

Communication evaluation module 406 is further connected to the feedback module 412. Feedback module 412 analyzes the recommendations from the speech analyzer 408 and the text analyzer 410 and processes the recommendations to form a feedback for the user. Feedback module 412 is also connected to message receive/send module 402. Feedback from the feedback module 412 is sent to the message receive/send module 402 and finally forwarded to the processor 314 to be provided to the user.

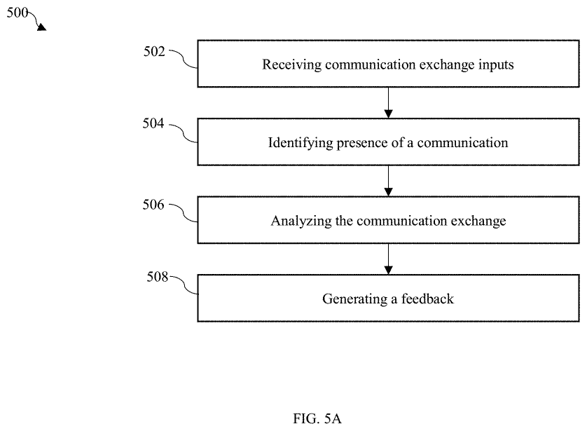

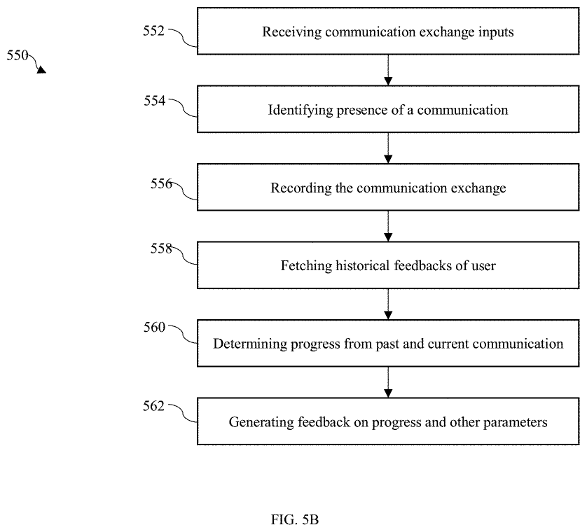

Referring to FIG. 5A, a flow chart illustrating an exemplary method 500 for communication exchange feedback, in accordance with an embodiment of the invention. The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

At step 502, the communication exchange inputs are received by the IM 206. The communication exchange inputs are then analyzed further, at step 504, to identify whether there is any communication exchange present or not. At step 506, the identified communication exchange is further analyzed to identify various parameters. In an embodiment of the invention, the parameters may be anyone or a combination of a language, filler words, confidence index, sentiment breakdown, accent analysis, negative words, sentence construction, using wrong terminology, and use of personal words.

Further, at step 508, based on the analyzed parameters as described above, a feedback is generated. In other embodiments, the feedback may also be generated by combining the user profile as has been described earlier with the analyzed parameters.

Referring to FIG. 5B, a flow chart illustrating an exemplary method 550 for communication exchange feedback, in accordance with another embodiment of the invention. Step 552 and 554 are similar to steps 502 and 504 as has been described earlier in conjunction with FIG. 5A. At step 556, the system 200 records the communication exchange when successfully identified at step 554. Recorded communication may be stored in the memory 316 or may be transmitted in real time to the IM 206. At step 558, the IM 206 fetches user profile history as has been explained earlier in the detailed description. At step 560, the IM determines the past feedback communication and the level of change the user has done by comparing utterances. Further at step 560, feedback is generated based on the real time utterances and the progress parameters as gathered from the profile of the user.

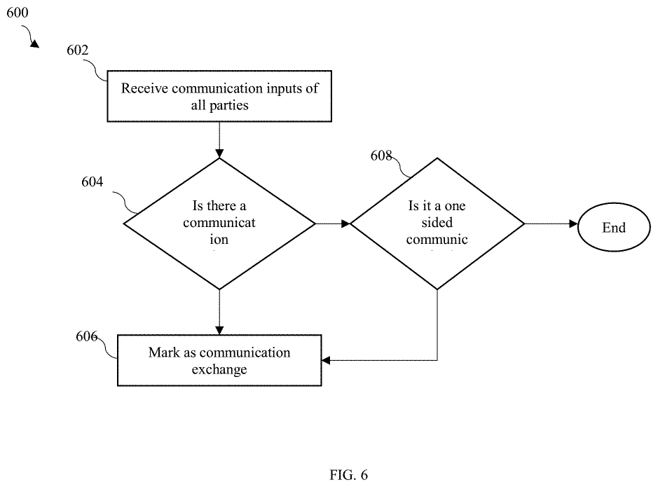

Referring to FIG. 6, a flow chart illustrating a method 600 for communication identification method, in accordance with an embodiment of the invention. At step 602, the communication determination module 404 receives communication inputs. At step 604, using a predefined set of rules of communication identification, the communication determination module 404 determines a presence of communication. In case communication exchange is identified, then at step 606 communication exchange is marked. However, in case the communication exchange is not determinable, then at step 608 the communication determination module 404 determines whether the communication exchange is a one-sided communication. In case it clears the one-sided communication criteria, then it is marked as a communication exchange. Otherwise the method 600 ends.

According to an exemplary usage, the system 200 analyzes user's previous conversations and provides real-time recommendations and feedback. In a specific example, during an interview, when user is speaking on a specific topic, system 200 may fetch user's previous conversation. System 200 may analyze previous conversations on the specific topic of present and will recommend to the user specific terminologies and topics that user had not used previously. System 200 may also provide analysis of previous conversations in terms of context, terminology, negative words and expressions, wrong words, slang etc. During current and further future conversations, if system 200 detects same topic is being discussed, it may provide some dos and don't′s to the user in real-time. For example, please do not use “word 1”, word 2”, these words have been used earlier.

In another exemplary usage, system 200 may provide real-time pronunciation feedbacks to the user. In case a user uses wrong pronunciation for a word, system 200 may utilize phonetic writing style to help the user pronounce the word correctly.

In yet another exemplary usage, system 200 may provide recommendations, based on past conversations, for time management. System 200 may analyze the time spent by the user previously on each previous topic. User may also be able to define desired time for each sub-topic. During conversations of future, system 200 may provide real-time recommendation to the user on how to manage his/her time to be able to cover all topics in the current conversation. For example, system 200 may provide a clock graph that displays time spent on each sub topic and time remaining to switch to a different sub topic

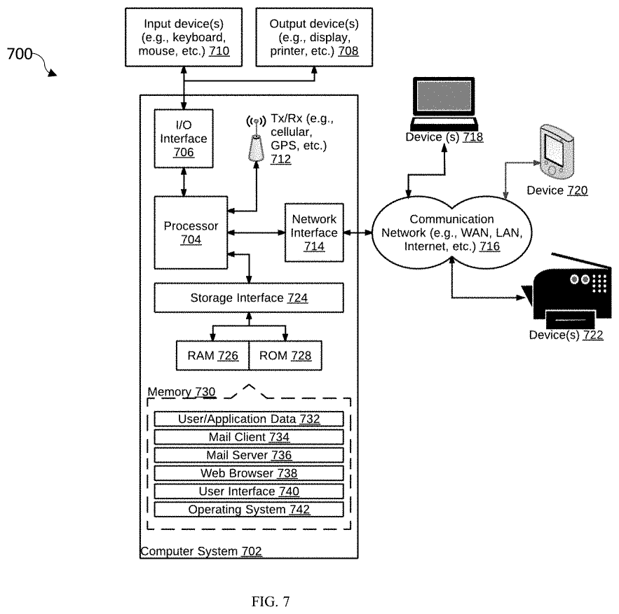

Referring to FIG. 7, illustrating a block diagram of an exemplary computer system 702 for implementing various embodiments is disclosed. Computer system 702 may comprise a central processing unit (“CPU” or “processor”) 704. Processor 704 may comprise at least one data processor for executing program components for executing user- or system-generated requests. A user may include a person, a person using a device such as such as those included in this disclosure, or such a device itself. Processor 704 may include specialized processing units such as integrated system (bus) controllers, memory management control units, floating point units, graphics processing units, digital signal processing units, etc. Processor 704 may include a microprocessor, such as AMD Athlon, Duron or Opteron, ARM's application, embedded or secure processors, IBM PowerPC, Intel's Core, Itanium, Xeon, Celeron or other line of processors, etc. Processor 704 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 704 may be disposed in communication with one or more input/output (I/O) devices via an I/O interface 706. I/O interface 706 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 706, computer system 702 may communicate with one or more I/O devices. For example, an input device 708 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 710 may be a printer, fax machine, video display (e.g., cathode ray tube (CRT), liquid crystal display (LCD), light-emitting diode (LED), plasma, or the like), audio speaker, etc. In some embodiments, a transceiver 712 may be disposed in connection with processor 704. Transceiver 712 may facilitate various types of wireless transmission or reception. For example, transceiver 712 may include an antenna operatively connected to a transceiver chip (e.g., Texas Instruments WiLink WL1283, Broadcom BCM4760IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 704 may be disposed in communication with a communication network 714 via a network interface 716. Network interface 716 may communicate with communication network 714. Network interface 716 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 714 may include, without limitation, a direct interconnection, local area network (LAN), wide area network (WAN), wireless network (e.g., using Wireless Application Protocol), the Internet, etc. Using network interface 716 and communication network 714, computer system 702 may communicate with devices 718, 720, and 722. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, or the like. In some embodiments, the computer system 602 may itself embody one or more of these devices.

In some embodiments, processor 704 may be disposed in communication with one or more memory devices (e.g., a RAM 726, a ROM 728, etc.) via a storage interface 724. Storage interface 724 may connect to memory devices 730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 730 may store a collection of program or database components, including, without limitation, an operating system 732, a user interface application 734, a web browser 736, a mail server 738, a mail client 740, a user/application data 742 (e.g., any data variables or data records discussed in this disclosure), etc. Operating system 732 may facilitate resource management and operation of computer system 702. Examples of operating system 732 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 734 may facilitate display, execution, interaction, manipulation, or operation of program components through textual or graphical facilities. For example, user interfaces may provide computer interaction interface elements on a display system operatively connected to computer system 702, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 702 may implement web browser 736 stored program component. Web browser 736 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 702 may implement mail server 738 stored program component. Mail server 738 may be an Internet mail server such as Microsoft Exchange, or the like. Mail server 738 may utilize facilities such as ASP, ActiveX, ANSI C++/C#, Microsoft .NET, CGI scripts, Java, JavaScript, PERL, PHP, Python, WebObjects, etc. Mail server 738 may utilize communication protocols such as internet message access protocol (IMAP), messaging application programming interface (MAPI), Microsoft Exchange, post office protocol (POP), simple mail transfer protocol (SMTP), or the like. In some embodiments, computer system 702 may implement mail client 740 stored program component. Mail client 740 may be a mail viewing application, such as Apple Mail, Microsoft Entourage, Microsoft Outlook, Mozilla Thunderbird, etc.

In some embodiments, computer system 702 may store user/application data 742, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination

Aspects of the present subject matter are described herein with reference to flowchart illustrations and/or block diagrams of methods and apparatus (systems) according to embodiments of the subject matter. It will be understood that each block of the flowchart illustrations and/or block diagrams, and combinations of blocks in the flowchart illustrations and/or block diagrams, can be implemented by computer readable program instructions.

While there has been shown and described herein what are presently considered the preferred embodiments of the present disclosure, it will be apparent to those skilled in the art that various changes and modifications can be made therein without departing from the scope of the present disclosure as defined by the appended claims.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While certain embodiments have been described, these embodiments have been presented by way of example only and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure. The accompanying claims and their equivalents are intended to cover such forms or modifications as would fall within the scope and spirit of the present disclosure.

What is claimed is:

1. A system for communication exchange feedback for a communication between a plurality of participants, comprising;
At least one device, corresponding to each participant of the plurality of participants, configured for communication exchange between the plurality of participants, the at least one device comprising;
A plurality of input modules, configured to receive communication exchange inputs actively and passively;
A plurality of output modules, configured to provide output;
An interception module, communicatively connected to the at least one device, configured to be initiated by a communication exchange, wherein the interception module comprises;
A communication determination module configured to identify presence of a communication from the communication exchange inputs received by the plurality of input modules;
A communication evaluation module configured to analyze the communication exchange of the plurality of participants, wherein the communication evaluation is based on a plurality of communication parameters;
A feedback module, communicatively coupled to the communication evaluation module, configured to generate a feedback wherein the feedback is provided to each of the plurality of participants, based on the communication evaluation of the communication exchange.

2. The system of claim 1, further comprising a storage module, communicably connected to the communication evaluation module.

3. The system of claim 1, wherein the communication evaluation module receives recommended feedback for the plurality of participants from the remote server.

4. The system of claim 1, wherein the recommended feedback is based on a profile of each of the plurality of participants.

5. The system of claim 1, wherein the profile of the plurality of participants is based on the historical feedbacks, adoption and corrections made.

6. The system of claim 1, wherein the feedback is provided in real time, at a user chosen time, after a meeting, or before next meeting.

7. The system of claim 1, wherein the device is anyone of a smartphone, a smartwatch, a laptop computer, a desktop computer, a tablet computer, a smart TV, a webcam, a video camera, an audio recorder, smart speaker, voice enabled devices, car infotainment, and a smart headset.

8. The system of claim 1, wherein the plurality of input modules is anyone or a combination of a key pad, a standalone button, a touch pad, a touch screen, and a microphone.

9. The system of claim 1, wherein the plurality of output modules, is anyone or a combination of a display, a speaker, and a haptic module.

10. The system of claim 1, wherein the interception module is a hardware module, or a software module.

11. The system of claim 10, wherein the hardware module is anyone of a standalone wearable device, a headset, or a microphone connectable to the device.

12. The system of claim 1, wherein communication exchange is anyone of a voice communication, and written communication.

13. The system of claim 1, wherein the actively received communication exchange is when communication is through the corresponding device.

14. The system of claim 1, wherein the passively received communication exchange is when communication is not done through the corresponding device.

15. The system of claim 1, wherein the feedback is a corrective recommendation provided to each of the plurality of participants or to only one participant where the communication is one way or heavy from one participant side only.

16. A computer implemented method for communication exchange feedback by an interception module connected to a device, method comprising;
Receiving, by a plurality of input modules of the device configured for communication exchange between a plurality of participants, communication exchange inputs;
Identifying, by a communication determination module of the interception module, presence of a communication from the communication exchange inputs;
Analyzing, by a communication evaluation module of the interception module, the communication exchange, wherein the communication evaluation is based on a plurality of communication parameters;
Generating, by a feedback module of the interception module, a feedback, wherein the feedback is provided to the plurality of participants, based on the communication evaluation of the communication exchange.

17. The method of claim 16, wherein the communication parameters are anyone or a combination of a language, filler words, confidence index, sentiment breakdown, accent analysis, negative words, sentence construction, using wrong terminology, and use of personal words.

18. The method of claim 16, wherein the feedback is provided to each of the plurality of participants in real time, at a user chosen time, after a meeting, or before next meeting.

19. The method of claim 16, wherein the feedback is provided to each of the at least two users is stored that is retrieved on demand.

20. A non-transitory computer-readable storage medium performing item identification, when executed by a computing device, cause the computing device to:
Receive, by a plurality of input modules of the device configured for communication exchange between a plurality of participants, communication exchange inputs;
Identify, by a communication determination module of the interception module, presence of a communication from the communication exchange inputs;
Analyze, by a communication evaluation module of the interception module, the communication exchange, wherein the communication evaluation is based on a plurality of communication parameters; and
Generate, by a feedback module of the interception module, a real time feedback, wherein the feedback is provided to the plurality of participants, based on the communication evaluation of the communication exchange.
